(19) United States
(12) Patent Application Publication
(10) Pub. No.: US 2026/0088445 A1
(43) Pub. Date: Mar. 26, 2026

(54) ELECTRODE ASSEMBLY AND RECHARGEABLE LITHIUM BATTERY INCLUDING THE SAME

(71) Applicants: SAMSUNG SDI CO., LTD., Yongin-si (KR); INDUSTRY-ACADEMIC COOPERATION FOUNDATION, DANKOOK UNIVERSITY, Yongin-si (KR)

(72) Inventors: Hosung YANG, Yongin-si (KR); Duckjae YOU, Yongin-si (KR); Changwon PARK, Yongin-si (KR); Jiye WOO, Yongin-si (KR); Byoung-Sun LEE, Yongin-si (KR); Seok-won HONG, Yongin-si (KR)

(73) Assignees: SAMSUNG SDI CO., LTD., Yongin-si (KR); INDUSTRY-ACADEMIC COOPERATION FOUNDATION, DANKOOK UNIVERSITY, Yongin-si (KR)

(21) Appl. No.: 19/330,225

(22) Filed: Sep. 16, 2025

(30) Foreign Application Priority Data
Sep. 20, 2024 (KR) 10-2024-0127635

(51) Int. Cl. H01M 50/44; H01M 10/052; H01M 50/414; H01M 50/434; H01M 50/446; H01M 50/489

(52) U.S. Cl. CPC H01M 50/44; H01M 10/052; H01M 50/414; H01M 50/434; H01M 50/446; H01M 50/489

(57) ABSTRACT

The present disclosure relates to an electrode assembly including a negative electrode including a current collector, a negative electrode active material layer on the current collector, and a coating layer on the negative electrode active material layer; and a positive electrode. The coating layer includes an organic layer including polyimide nanofibers and a quinoline derivative. An average diameter of the polyimide nanofibers is less than or equal to about 200 nm. The present disclosure also relates to a method for manufacturing the electrode assembly.

### CROSS-REFERENCE TO RELATED APPLICATION

This application claims priority to Korean Patent Application No. 10-2024-0127635, filed in the Korean Intellectual Property Office on Sep. 20, 2024, the entire contents of which are incorporated herein by reference.

### BACKGROUND

### 1. Field

The present disclosure discloses an electrode assembly, and a rechargeable lithium battery including the electrode assembly.

### 2. Description of the Related Art

With increasing presence of electronic devices that use batteries, such as, e.g., mobile phones, laptop computers, and electric vehicles, the demand for rechargeable batteries with high energy density and high capacity is increasing. Accordingly, improving the performance of rechargeable lithium batteries may be advantageous.

Rechargeable lithium batteries include a positive electrode and a negative electrode including an active material capable of intercalating and deintercalating lithium ions, and an electrolyte solution. The rechargeable lithium batteries generate electrical energy through oxidation and reduction reactions when lithium ions are intercalated and deintercalated from the positive electrode and the negative electrode.

The rechargeable lithium battery can be recharged and used continuously after discharge, and thus shows differences in performance depending on the charge and discharge state. Therefore, improving the performance of rechargeable lithium batteries by improving the charging method may be advantageous.

### SUMMARY

Some example embodiments include an electrode assembly having desired or improved mechanical strength and improved electrospinning properties while reducing or minimizing deformation of the electrode by enabling low-temperature imidization, a method for manufacturing the electrode assembly, and a rechargeable lithium battery including the electrode assembly.

Some example embodiments include an electrode assembly including a negative electrode including a current collector, a negative electrode active material layer on the current collector, and a coating layer on the negative electrode active material layer; and a positive electrode. The coating layer includes an organic layer including polyimide nanofibers and a quinoline-based derivative, and an average diameter of the polyimide nanofibers is less than or equal to about 200 nm.

Some example embodiments include a method for manufacturing an electrode assembly which includes mixing polyamic acid, a solvent, and a quinoline-based derivative to prepare a solution for forming an organic layer; electrospinning the solution for forming the organic layer onto a negative electrode active material layer to manufacture a negative electrode active material layer coated with an organic layer; and heat-treating a negative electrode active material layer coated with the organic layer at a temperature of greater than or equal to about 50° C. and less than about 200° C. to form a coating layer on the negative electrode active material layer.

Some example embodiments include a rechargeable lithium battery including the electrode assembly and an electrolyte solution.

The electrode assembly according to some example embodiments has the advantage of having desired or improved mechanical strength and improved electrospinning properties while reducing or minimizing deformation of the electrode, and a rechargeable lithium battery including the electrode assembly has the advantage of improved battery characteristics.

### BRIEF DESCRIPTION OF THE DRAWINGS

FIG. 1 is a cross-sectional view schematically illustrating an electrode assembly according to some example embodiments.

FIG. 2 to FIG. 5 are schematic views illustrating rechargeable lithium batteries according to some example embodiments.

FIG. 6A to FIG. 6D are SEM images showing polyimide nanofibers formed by electrospinning on a negative electrode manufactured in Example 1 at different magnifications.

FIG. 7A to FIG. 7D are SEM images showing polyimide nanofibers formed by electrospinning on a negative electrode manufactured in Comparative Example 1 according to magnification.

FIG. 8 is a graph showing an average diameter, a standard deviation of the diameter, a maximum value of the diameter, and a minimum value of the diameter of polyimide nanofibers manufactured in Example 1.

FIG. 9 is a graph showing an average diameter, a standard deviation of the diameter, a maximum value of the diameter, and a minimum value of the diameter of polyimide nanofibers prepared in Comparative Example 1.

FIG. 10 is a graph showing the results of DSC analysis of a negative electrode active material layer electrospinning-coated with the solution for forming the organic layer of Example 1.

FIG. 11 is a graph showing the results of DSC analysis of a negative electrode active material layer coated with an organic layer of Comparative Example 1.

FIG. 12 is a graph showing the temperature-dependent imidization index of polyimides manufactured in Example 1 and Comparative Example 1, measured using FT-IR.

FIG. 13 is a graph evaluating the initial efficiency characteristics of the rechargeable lithium battery cell of Example 1.

FIG. 14 is a graph evaluating the initial efficiency characteristics of the rechargeable lithium battery cell of Comparative Example 1.

FIG. 15 is a flowchart illustrating a method of manufacturing an electrode assembly, according to an example embodiment.

### DETAILED DESCRIPTION

Hereinafter, example embodiments of the present disclosure are described in detail. However, these embodiments are presented as an example, and the present disclosure is not limited thereto, and the present disclosure is defined by the scope of the claims described below.

The terminology used herein is used to describe example embodiments only, and is not intended to limit the present disclosure. The singular expression includes the plural expression unless the context clearly dictates otherwise.

As used herein, “combination thereof” indicates a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, and the like, are exaggerated for clarity and like reference numerals designate like elements throughout the specification. It is understood that when an element such as a layer, film, region, or substrate is referred to as being “on” another element, the element can be directly on the other element, or intervening elements may also be present therebetween. In contrast, when an element is referred to as being “directly on” another element, there are no intervening elements present therebetween.

In addition, “layer” herein includes not only a shape formed on the whole surface when viewed from a plan view, but also a shape formed on a partial surface.

Unless otherwise specified in this specification, what is indicated in the singular may also include the plural. In addition, unless otherwise specified, “A or B” may mean “including A, including B, or including A and B.”

“Metal” is interpreted as a concept including ordinary metals, transition metals and metalloids (semi-metals).

As used herein, when a definition is not otherwise provided, a particle diameter may be an average particle diameter. In addition, the particle diameter means the average particle diameter (D50), which means the diameter of particles having a cumulative volume of 50 volume % in the particle size distribution. The average particle size (D50) may be measured by a method known to those skilled in the art, for example, by a particle size analyzer, or by a transmission electron microscope image, or a scanning electron microscope image. Alternatively, a dynamic light-scattering measurement device is used to perform a data analysis, and the number of particles is counted for each particle size range. From this, the average particle diameter (D50) value may be easily obtained through a calculation. Alternatively, the number of particles can be measured using a laser diffraction method. When measuring by the laser diffraction method, for example, the particles to be measured are dispersed in a dispersion medium, and then introduced into a commercially available laser diffraction particle diameter measuring device (e.g., Microtrac MT 3000), and ultrasonic waves of about 28 kHz with an output of 60 W are irradiated to calculate an average particle diameter (D50) on the basis of 50% of the particle diameter distribution in the measuring device.

As used herein, when a definition is not otherwise provided, “substituted” refers to replacement of at least one hydrogen of a substituent or a compound by deuterium, a halogen, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

For example, “substituted” may refer to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, “substituted” may refer to replacement of at least one hydrogen of a substituent or a compound by deuterium, a halogen, a C1 to C20 alkyl group, a C6 to C30 aryl group, a C1 to C10 fluoroalkyl group, or a cyano group. Alternatively, “substituted” may refer to replacement of at least one hydrogen of a substituent or a compound by deuterium, a halogen group, a C1 to C5 alkyl group, a C6 to C18 aryl group, a C1 to C5 fluoroalkyl group, or a cyano group. For example, “substituted” may refer to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

An electrode assembly according to some example embodiments includes a negative electrode including a current collector, a negative electrode active material layer on the current collector, and a coating layer on the negative electrode active material layer; and a positive electrode. The coating layer includes an organic layer including polyimide nanofibers and a quinoline-based derivative, and an average diameter of the polyimide nanofibers is less than or equal to about 200 nm.

The electrode assembly for a rechargeable lithium battery according to some example embodiments includes a negative electrode and a positive electrode. The negative electrode includes a current collector, a negative electrode active material layer on the current collector, and a coating layer located on the negative electrode active material layer and, e.g., integrally formed with the negative electrode active material layer.

Because the coating layer is positioned between the positive and negative electrodes and constitutes a separator to reduce or prevent short circuits, the electrode assembly according to some example embodiments may not include a separate separator.

In examples, because the electrode assembly according to some example embodiments includes no separate separator, there may not be a need to perform a lamination process for combining a separator with the electrodes, thus manufacturing a battery more economically.

In addition, the fact that the coating layer is integrated with a negative electrode active material layer does not mean that the coating layer is formed as a separate layer from the negative electrode active material layer, wherein as the coating layer is directly formed on the negative electrode active material layer, so that a portion of the coating layer may be permeated into the negative electrode active material layer and dried, the negative electrode active material layer and the coating layer are more firmly bonded.

In examples, the coating layer is integrated with the negative electrode active material layer so that when the electrode assembly is measured with SEM, and the like, the negative electrode active material layer is separated from the coating layer but has an uneven (unflat) interface (boundary portion) with the coating layer.

In addition, as the negative electrode active material layer is integrated with the coating layer, because the negative electrode active material layer is in close contact with the coating layer, the interface of the coating layer with the negative electrode active material layer may be dense without pores.

In examples, as the coating layer is integrated with the negative electrode active material layer, the coating layer may be in a more firmly bonded state with the negative electrode active material layer. In addition, a polypropylene film, which is generally used as a separator, may experience dimensional changes due to thermal shrinkage, and the like, when repeatedly charged and discharged, which may resultantly bring about a decrease in a separation function of the positive and negative electrodes, causing issues such as, e.g., short circuits, and the like. However, the electrode assembly according to some example embodiments, in which the coating layer functioning as a separator is integrated with the negative electrode active material layer, may not cause issues such as thermal shrinkage and the like.

In addition, as the coating layer is integrated with the negative electrode active material layer, heat resistance and insulation may be improved, while reducing resistance. When the coating layer is formed as a separate layer, and then bonded with the negative electrode active material layer rather than integrated with the negative electrode active material layer, because the coating layer is not integrated with the negative electrode active material layer, there may be disadvantages of increasing lithium transfer resistance and adding another process for the integration.

In addition, the coating layer according to some example embodiments may include at least one organic layer, and according to other example embodiments, at least one inorganic layer may be further included in addition to the at least one organic layer.

For example, the coating layer may include two or more organic layers and about 2 to about 10 organic layers. In examples, when two or more organic layers are included, the density of the coating layer may be increased, which may be an advantage of reducing or suppressing dendrites, and thus enhancing safety.

In addition to the organic layers, about two or more inorganic layers may be included, and according to some example embodiments, about 2 to about 10 inorganic layers may be included. When two or more organic layers, and/or two or more inorganic layers are included, each of the organic layers and the inorganic layers may intersect each other, or the organic layers themselves may be formed, while the inorganic layers themselves are formed without the intersection.

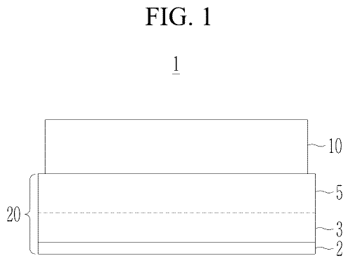

An electrode assembly including a coating layer is schematically illustrated in FIG. 1.

As illustrated in FIG. 1, the electrode assembly 1 is composed of or include a negative electrode 20 and a positive electrode 10, and the negative electrode 20 includes a current collector 2, a negative electrode active material layer 3, and a coating layer 5.

In FIG. 1, the negative electrode active material layer 3 and the coating layer 5 are shown as being formed as separate layers, but this is only a notation to indicate the negative electrode active material layer and the coating layer, and the dotted line therebetween indicates that the negative electrode active material layer and the coating layer are integrated.

According to some example embodiments, because the electrode assembly has a negative electrode active material layer and a coating layer that are integrated, the sizes of the negative electrode active material layer and the coating layer in the width direction can be substantially the same.

### Organic Layer

The organic layer includes polyimide nanofibers and a quinoline-based derivative.

In general, after coating the polyamic acid nanofibers on an electrode, imidization of the polyamic acid into polyimide is required to be performed at a high temperature in a range of about 200° C. or higher. Herein, the electrode is deformed at the high temperature of about 200° C. or higher (for example, damage on a binder inside the electrode or migration thereof in a thickness direction of the electrode).

In some example embodiments, the quinoline-based derivative capable of lowering the imidization temperature is added to a polyamic acid dope, so that the imidization may be performed at a low temperature. For example, the quinoline-based derivative includes nitrogen having an unshared electron pairs, where the nitrogen may deprotonate hydrogen in an amide group of the polyamic acid. In addition, the unshared electron pairs of the nitrogen in the amide group forms a bond 25 with carbon of a carboxyl group in the polyamic acid, thereby lowering the imidization temperature of the polyamic acid.

Accordingly, deformation of the electrode may not only be reduced or minimized, but also a diameter of polyimide nanofibers and uniformity of the diameter may be improved, providing an electrode assembly with desired or improved mechanical strength and improved electrospinning properties.

In addition, a rechargeable lithium battery according to some example embodiments includes the electrode assembly, which may improve battery characteristics such as initial efficiency, cycle-life characteristics, and the like, of the battery.

For example, the average diameter of the polyimide nanofibers may be less than or equal to about 200 nm, for example less than or equal to about 195 nm, or less than or equal to about 192 nm.

For example, the standard deviation of the diameter of the polyimide nanofibers may be greater than or equal to about 50 nm, greater than or equal to about 60 nm, or greater than or equal to about 70 nm, and less than or equal to about 90 nm, less than or equal to about 80 nm, or less than or equal to about 75 nm.

For example, the maximum diameter of the polyimide nanofibers may be greater than or equal to about 250 nm, greater than or equal to about 300 nm, or greater than or equal to about 320 nm, and may be less than or equal to about 500 nm, less than or equal to about 400 nm, or less than or equal to about 350 nm.

For example, the minimum diameter of the polyimide nanofibers may be greater than or equal to about 40 nm, greater than or equal to about 50 nm, or greater than or equal to about 60 nm, and may be less than or equal to about 100 nm, less than or equal to about 80 nm, or less than or equal to about 70 nm.

When the average diameter, standard deviation of diameter, maximum value and minimum value of diameter of the polyimide nanofibers satisfy the above numerical ranges, an electrode assembly having desired or improved mechanical strength and improved electrospinning properties can be realized.

The average diameter of the polyimide nanofibers may be calculated by randomly or non-systematically measuring the diameters of about 50 fibers in a scanning electron microscope image of the coating layer, and calculating the arithmetic mean of the measured diameters.

The standard deviation of the diameter of the polyimide nanofibers can be calculated using the average diameter of the fibers calculated above and the diameter values of about 50 fibers.

In addition, the maximum value of the diameter of the polyimide nanofibers may be obtained by measuring the diameters of about 50 fibers and taking the largest value among them, and the minimum value of the diameter of the polyimide nanofibers may be obtained by measuring the diameters of about 50 fibers and taking the smallest value among them.

For example, the imidization index at about 140° C. derived from the FT-IR analysis data of the polyimide nanofibers may be in a range of about 0.8 to about 0.9, for example, about 0.8 to about 0.88, or about 0.8 to about 0.86. When the above numerical range is satisfied, about 80% or more of polyamic acid is imidized into polyimide even at a low temperature of about 140° C.

For example, the quinoline-based derivative may include a compound represented by Chemical Formula 1.

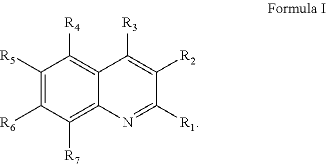

In Chemical Formula 1, R₁ to R₇ may be the same or different, and may be or include at least one of hydrogen, a halogen, a hydroxyl group, a substituted or unsubstituted C1 to C30 alkyl group, a substituted or unsubstituted C1 to C10 alkylsilyl group, a substituted or unsubstituted C6 to C30 arylsilyl group, a substituted or unsubstituted C3 to C30 cycloalkyl group, a substituted or unsubstituted C3 to C30 heterocycloalkyl group, a substituted or unsubstituted C6 to C30 aryl group, a substituted or unsubstituted C2 to C30 heteroaryl group, a substituted or unsubstituted C1 to C20 alkoxy group, or a combination thereof.

For example, R₁ to R₇ may each independently be or include at least one of hydrogen, a halogen group, a hydroxyl group, a substituted or unsubstituted C1 to C30 alkyl group, or a combination thereof. As an example, when all of R₁ to R₇ may be hydrogen, the quinoline-based derivative may correspond to quinoline.

For example, the boiling point of the quinoline-based derivative may be in a range of about 150° C. to about 300° C., and for example, the boiling point of the quinoline-based derivative may be about 200° C. to about 300° C., about 150° C. to about 250° C., about 200° C. to about 250° C., or about 200° C. to about 240° C.

For example, the vapor pressure of the quinoline-based derivative may be in a range of about 0.1 Pa to about 20 Pa, and for example, the vapor pressure of the quinoline-based derivative may be about 0.1 Pa to about 10 Pa, about 1 Pa to about 20 Pa, about 1 Pa to about 10 Pa, about 5 Pa to about 20 Pa, or about 5 Pa to about 10 Pa.

When the boiling point of the quinoline-based derivative is lower than about 150° C., or the vapor pressure is higher than about 20 Pa, the quinoline-based derivative may vaporize at the beginning of the thermal imidization reaction, thereby reducing a function thereof as a promoter for the low-temperature imidization reaction.

In addition, when the boiling point of the quinoline-based derivative exceeds about 300° C., or the vapor pressure is less than about 0.1 Pa, an excessive amount of quinoline-based derivative may remain in the coating layer after thermal imidization, which may increase battery resistance.

For example, the content of the polyimide nanofibers may be in a range of about 50 wt % to about 100 wt % based on 100 wt % of the coating layer, and for example, the content of the quinoline-based derivative may be in a range of about 0.1 wt % to about 5 wt % based on 100 wt % of the coating layer.

When the above numerical range is satisfied, an electrode assembly having desired or improved mechanical strength and improved electrospinning properties can be realized.

For example, the organic layer may have a three-dimensional network structure, for example, a woven structure or a non-woven structure, and the organic layer having such a three-dimensional network structure may be formed, for example, by an electrospinning method. However, the method for forming the organic layer is not limited to electrospinning, and any method may be used as long as an organic layer having a three-dimensional network structure can be formed.

In examples, when the organic layer has a three-dimensional network structure, such as a woven structure or a non-woven structure, there may be an advantage in reducing or minimizing the Li ion movement resistance. The existence of the organic layer as a three-dimensional network structure means a porous layer in which pores are formed. When the organic layer is formed as a dense layer, the movement distance of Li ions increases, that is, the relative resistance to Li ion movement increases, which is not suitable. In addition, the organic layer can be separated from the active material layer and is not suitable because it is not integrated with the active material layer.

For example, because the organic layer is integrated with the negative electrode active material layer, at least a portion of the polyimide nanofibers may be penetrated into the inside of the negative electrode active material layer.

For example, the organic layer may be or include a porous layer including a plurality of pores, and the average diameter of the pores may be the same as the average diameter of the polyimide nanofibers described above. For example, the average diameter of the pores may be less than or equal to about 200 nm, for example less than or equal to about 195 nm, or less than or equal to about 192 nm. When the above numerical range is satisfied, an electrode assembly having desired or improved mechanical strength and improved electrospinning properties can be implemented.

For example, the organic layer may further include a heat-resistant polymer, and the heat-resistant polymer may include a polymer that is or includes at least one of polypropylene (PP), polyester, polyamide, polyimide (PI), polyetherimide (PEI), polyetheretherketone (PEEK), polyphenyl terephthalamide (PTA), polysulfone (PSF), polyethersulfone (PES), polyphenylene sulfide (PPS), polyamideimide (PAI), polyetherimide (PEI), polyacrylonitrile (PAN), polyvinylidene fluoride (PVDF), polyvinylidene fluoride-hexafluoropropylene (PVDF-HFP), polycarbonate (PC), polyvinyl chloride (PVC), polyvinylidene chloride, polyethylene glycol derivatives, polyoxide, polyvinylacetate, polystyrene (PS), polyvinylpyrrolidone (PVP), a copolymer thereof, or a combination thereof. The heat-resistant polymer may be a non-aqueous polymer. When an aqueous polymer is used, it may be more challenging to form fibers by electrospinning, which may not be suitable.

### Inorganic Layer

The inorganic layer exists as a dense layer, and the inorganic layer can be formed, for example, by an electrospray method. However, the method for forming the inorganic layer is not limited to the electrospray method, and as long as the inorganic layer can be formed into a dense layer, the electrospray method may be carried out using a general coating process such as, e.g., a doctor blade. When the inorganic layer exists as a dense layer, the formation of Li dendrites can be reduced or suppressed more effectively, and when the inorganic layer exists as a porous layer, a short circuit may occur during charge and discharge, which is not suitable.

The inorganic layer may include inorganic materials such as or including at least one of alumina (Al₂O₃), boehmite (aluminum oxide hydroxide), zirconia, titanium oxide (TiO₂), and silica (SiO₂), or a combination thereof.

The coating layer, which includes both the organic layer and the inorganic layer, may provide a heat-resistant synergistic effect by including a polymer, particularly, a heat-resistant polymer, and thereby, reducing or suppressing the issue of damaging a negative electrode during the battery manufacturing process. In addition, there may be another effect of reducing or suppressing generation of lithium dendrites during the charge/discharge and further an effect of increasing heat resistance and puncture strength by including an inorganic material. These effects may be challenging to obtain when the polymer and the inorganic material are mixed to form a single layer, which may not be desirable.

When the organic layer is first formed, when the coating layer further includes the inorganic layer in addition to the organic layer, because the organic layer is formed into a three-dimensional network structure by electrospinning, when the inorganic layer is formed onto the organic layer by electrospraying, inorganic particles of the inorganic material may be inserted into the organic layer. Accordingly, the coating layer including the organic layer and the inorganic layer may be all integrated with the negative electrode active material layer.

For example, the coating layer may have a thickness in a range of about 1 μm to about 25 μm, for example, greater than or equal to about 5 μm or greater than or equal to about 10 μm and less than or equal to about 10 μm, less than or equal to about 20 μm, or less than or equal to about 15 μm.

For example, the organic layer may have a thickness in a range of about 1 μm to about 25 μm, for example, about 1 μm to about 20 μm, or about 5 μm to about 15 μm.

For example, when the coating layer includes the organic layer alone, the thickness of the organic layer may be a thickness of the coating layer. The thickness of the organic layer refers to a thickness of a region where the organic material exists in the coating layer integrated with the negative electrode active material layer, but not a thickness of a region where the organic material independently separately exists.

When the thickness of the coating layer is included within the above ranges, a desired high density may be obtained, which leads to effective reduction or suppression of generation of Li dendrite during the charging and discharging.

For example, the coating layer may have a peel strength that is greater than or equal to about 0.1 gf/mm, for example, about 0.1 gf/mm to about 3.0 gf/mm.

In some example embodiments, even when the organic layer is positioned to be in contact with the negative electrode active material layer, the coating layer may have a peel strength that is greater than or equal to about 0.1 gf/mm, or in a range of about 0.1 gf/mm to about 3.0 gf/mm. The peel strength of the coating layer indicates an adhesion between the negative electrode active material layer and the coating layer, wherein the peel strength falls within the ranges, which confirms that the coating layer is substantially strongly adhered to the negative electrode active material.

For example, the peel strength of the coating layer may be measured by attaching a 1.5 cm-wide adhesive tape (Celotape (registered trademark) made by 3M) to the negative electrode fixed onto a stainless steel plate and using a peel tester (Model name: KP-M1T-s, Manufacturer: KIPAE E&T). For example, the peel strength may be measured under the conditions of about 1 kg load cell and a peel speed of about 100 mm/min in a 180° peel strength test.

In some example embodiments, the coating layer may have a maximum tensile strength in a range of about 60 MPa to about 100 MPa, for example, about 65 MPa to about 100 Mpa, or about 67 MPa to about 100 MPa.

The tensile strength of the coating layer may be measured by collecting the coating layer from the negative electrode according to an example embodiment, and then using an INSTRON universal testing machine. According to ASTM D882, a sample has a gauge length and width of about 250 mm and about 10 mm, and a tensile load is applied to the sample at a tensile speed of about 100 mm/min, until the sample is destroyed, to measure a maximum load, and the maximum load is divided by an initial cross-section area of the sample.

When the coating layer has the peel strength and the maximum tensile strength within the above ranges, desired or improved high rate capability may be obtained, thereby achieving substantially improved cycle-life characteristics.

### Negative Electrode

The negative electrode for a rechargeable lithium battery includes a current collector, and a negative electrode active material layer on the current collector. The negative electrode active material layer may include a negative electrode active material, and may further include a binder and/or a conductive material.

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, for example crystalline carbon, amorphous carbon or a combination thereof. The crystalline carbon may be graphite such as non-shaped, sheet-shaped, flake-shaped, sphere-shaped, or fiber-shaped natural graphite or artificial graphite, and the amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles, and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder attaches the negative electrode active material particles to each other, and attaches the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, fluoride, polystyrene, polyurethane, polytetrafluoroethylene, polyvinylidene polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material capable of being fibrous, and may be or include, for example, at least one of polytetrafluoroethylene, polyvinylidene fluoride, a polyvinylidene fluoride-hexafluoropropylene copolymer, polyethylene oxide, or a combination thereof.

The conductive material may impart conductivity to the electrode, and any material that does not cause adverse chemical change and that conducts electrons can be used in the battery. Examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in the form of a metal powder or a metal fiber; a conductive polymer such as a polyphenylene derivative; or a mixture thereof.

The negative electrode current collector may include at least one of a copper foil, a nickel foil, a stainless steel foil, a titanium foil, a nickel foam, a copper foam, a polymer substrate coated with a conductive metal, and a combination thereof.

### Method for Manufacturing Electrode Assembly

A method for manufacturing the electrode assembly according to some example embodiments includes (1) mixing polyamic acid, a solvent, and a quinoline-based derivative to prepare a solution for forming an organic layer; (2) electrospinning the solution for forming the organic layer onto a negative electrode active material layer to manufacture a negative electrode active material layer coated with an organic layer; and (3) heat-treating a negative electrode active material layer coated with the organic layer at a temperature that is greater than or equal to about 50° C. and less than about 200° C. to form a coating layer on the negative electrode active material layer.

The method for manufacturing the electrode assembly according to some example embodiments has advantages of providing an electrode assembly having desired or improved mechanical strength and improved electrospinning properties as well as reducing or minimizing deformation of an electrode by mixing a promoter including a quinoline-based derivative into a polyamic acid dope so that thermal imidization may occur at a low temperature of less than about 200° C.

First, polyamic acid, a solvent, and the quinoline-based derivative may be mixed to prepare an electrospinning solution for forming an organic layer.

For example, the step may be performed by dissolving the polyamic acid in the solvent to prepare a polyamic acid solution, and then mixing the polyamic acid solution with the quinoline-based derivative.

For example, the solvent may include at least one of dimethyl acetamide, dimethylacetate, dimethyl formamide, dimethylsulfoxide, acetone, or a combination thereof.

In addition, the solution for forming the organic layer may further include the heat-resistant polymer described above in addition to the polyamic acid, and the heat-resistant polymer may be or include a polymer such as at least one of polypropylene (PP), polyester, polyamide, polyimide (PI), polyetherimide (PEI), polyetheretherketone (PEEK), polyphenyl terephthalamide (PTA), polysulfone (PSF), polyethersulfone (PES), polyphenylene sulfide (PPS), polyamideimide (PAI), polyetherimide (PEI), polyacrylonitrile (PAN), polyvinylidene fluoride (PVDF), polyvinylidene fluoride-hexafluoropropylene (PVDF-HFP), polycarbonate (PC), polyvinyl chloride (PVC), polyvinylidene chloride, polyethylene glycol derivatives, polyoxide, polyvinylacetate, polystyrene (PS), polyvinylpyrrolidone (PVP), a copolymer thereof, or a combination thereof.

The quinoline-based derivative is the same as described above, so a detailed description thereof is omitted here.

For example, a content of the polyamic acid may be in a range of about 5 wt % to about 20 wt %, for example, about 5 wt % to about 15 wt % or about 5 wt % to about 10 wt % based on 100 wt % of the solution for forming an organic layer.

When the content of the polyamic acid is within the above ranges, an organic layer with an appropriate or desired thickness may be formed. In addition, when the content of the polyamic acid is less than about 5 wt % based on 100 wt % of the solution for forming an organic layer, there may be difficulty in forming fibers during the electrospinning, and when the content of the polyamic acid is greater than about 20 wt %, the electrospinning may not be suitably performed, for a tip may be blocked, making spinning challenging or impossible, or the fibers may be spun to be uneven and thick.

In the solution for forming an organic layer, a content of the quinoline-based derivative may be in a range of about 0.02 wt % to about 10 wt % based on 100 wt % of a total amount of the solution, for example, about 0.1 wt % to about 10 wt %, about 0.5 wt % to about 10 wt %, about 1 wt % to about 10 wt %, or about 5 wt % to about 10 wt %.

When the content of the quinoline-based derivative is less than about 0.02 wt % based on 100 wt % of the solution for forming an organic layer, the effect thereof as a low-temperature imidization catalyst may be insignificant, but when the content of the quinoline-based derivative is greater than about 10 wt %, it may be difficult to form fibers by the electrospinning.

Subsequently, the solution for forming an organic layer is electrospun onto the negative electrode active material layer to form the negative electrode active material coated with an organic layer.

The electrospinning process may be performed by positioning one nozzle pack consisting of or including tips having a hole size of about 23G (gauge) to about 30G and a collector roller at a predetermined or desired interval, adding the electrospinning solution to the tips, placing a target substrate on the collector roller, and applying a voltage in a range of about 35 kV to about 100 kV to the tips.

The number of the tips may be adjusted as desired depending on types, contents, and the like, of a polymer included in the solution, for example, in a range of about 1 to about 1000.

The predetermined or desired distance between the nozzle pack and the target substrate may be in a range of about 10 cm to about 20 cm.

When the tips have a hole size in a range of about 25G to about 30G, the coating layer may have a desired shape.

According to the electrospinning process, the polymer solution (for example, the polyamic acid solution) is spun and stretched into a fiber shape, and then spun onto the target substrate in the form of nanofibers, thereby forming the coating layer. For example, the electrospinning solution hangs in the form of a droplet at the ends of the tips, and when the voltage is applied thereto, charges are accumulated on the surface of the polymer solution droplet, and a repulsive force occurs among the charges. Accordingly, the repulsive force among the charges is directed in an opposite direction to the surface tension of the solution, and when the voltage reaches a threshold point, a Taylor cone may be formed, and from the tip end of the Taylor cone, the polymer solution is jetted, goes through multi-axial stretching in a whipping region, and collected into a non-woven fabric by the collector roller to form nanofibers.

Herein, the electrospinning process may be performed at a temperature in a range of about 20° C. to about 30° C. under a relative humidity of about 0% to about 60%. When the electrospinning process is performed under the temperature and relative humidity conditions, there may be an advantage of keeping the fibers at a predetermined or desired thickness, while spinning.

In addition, a rolling speed of the collector roller may be adjusted to secure a desired thickness of the coating layer, for example, in a range of about 0.1 m/min to about 3 m/min. Furthermore, the electrospinning solution may be adjusted to be discharged from the tips at a flow rate in a range of about 1 ml/min to about 100 ml/min.

In addition, interference among the tips may be reduced or minimized to secure substantially uniform electrospinning by controlling tip air as desired. The tip air may be controlled by flowing compressed air at a pressure in a range of about 0.01 MPa to about 0.5 MPa.

After the electrospinning process, a drying process may be performed with hot air at a temperature in a range of about 70° C. to about 110° C.

For example, when the coating layer includes at least one organic layer, for example, at least two organic layers, the electrospinning process may be performed twice or more times.

As the organic layer is formed by electrospinning, the formed organic layer may have a three-dimensional network structure. When the organic layer is formed by directly coating the solution or by dipping the target substrate in the solution rather than electrospinning, the organic layer may be dense, which is not desirable or appropriate. In addition, the solvent remaining in the electrode plate may excessively or substantially increase a thickness of the electrode plate, which may not improve the energy density per battery volume as desired. Furthermore, the densely formed organic layer itself may constitute a resistance layer, increasing resistance to Li ion movement, and thus deteriorating battery performance.

As in some example embodiments, as the organic layer is formed by the electrospinning process, because the solvent may be volatilized, a spring back phenomenon, where the solvent damages the negative electrode, may be better reduced or suppressed.

When the coating layer further includes the inorganic layer, the inorganic layer may be formed by electro-spraying the solution for forming an inorganic layer onto the target substrate. The solution for forming an inorganic layer may include a polymer and a solvent.

A method of forming the inorganic layer may be performed by electrospraying, for example, by a general coating process such as a doctor blade and the like, as long as the inorganic layer is dense. In some example embodiments, the inorganic layer is formed by the electrospraying process, which may volatilize the solvent and thus better reduce or suppress the spring back phenomenon where the solvent damages the negative electrode.

Hereinafter, a method of forming the inorganic layer by the electrospraying is explained.

For example, the method of forming the inorganic layer by electrospraying may include a method of electrospraying the solution for forming an inorganic layer onto the target substrate. The solution for forming an inorganic layer may include an inorganic material, a binder, and a solvent.

The electrospraying process may be performed by positioning one nozzle pack consisting of or including tips having a hole size in a range of about 23G (gauge) to about 30G and a collector roller at a predetermined or desired interval, adding the electrospinning solution to the tips, placing the target substrate on the collector roller, and applying a voltage in a range of about 35 kV to about 80 kV to the tips.

The number of the tips may be adjusted as desired depending on types, contents, and the like, of the inorganic material included in the inorganic solution, for example, a range of about 1 to about 1000.

The predetermined or desired distance between the nozzle pack and the target substrate may be in a range of about 10 cm to about 20 cm.

When the tips have a hole size in a range of about 25G to about 30G, the inorganic layer may have a desired shape.

In addition, a rolling speed of the collector roller may be adjusted to secure an appropriate or desired thickness of the inorganic layer and may be, for example, in a range of about 0.1 m/min to about 3.0 m/min. Furthermore, the solution for forming an inorganic layer discharged from the tips may be adjusted to have a solid content in a range of about 20 μl/min to about 100 μl/min.

In examples, interference among the tips may be reduced or minimized to secure substantially uniform electrospraying by controlling tip air as desired. The tip air may be controlled by flowing compressed air at a pressure in a range of about 0.01 MPa to about 0.5 MPa.

After the electrospraying process, a drying process may be performed with hot air at a temperature in a range of about 90° C. to about 110° C.

When at least about one inorganic layer, for example, at least about two inorganic layers, are included as the coating layer, the electrospraying process may be at least twice performed.

In the solution for forming the inorganic layer, the inorganic material may be as described above, and the solvent may be or include at least one of water, ethanol, dimethyl acetate, N-methylpyrrolidone, dimethylformamide, dimethylacetamide, dimethyl sulfoxide, acetone, or a combination thereof. The binder may be or include at least one of polyvinyl alcohol, carboxymethylcellulose, polyvinylidene fluoride, polyamideimide, polyvinylpyrrolidone, polyacrylonitrile, a copolymer thereof, or a combination thereof.

In the solution for forming the inorganic layer, a content of the inorganic material may be in a range of about 5 wt % to about 30 wt % based on 100 wt % of the total solution. In the solution for forming the inorganic layer, a content of the binder may be in a range of about 0.1 wt % to about 5 wt % based on 100 wt % of the total solution.

After forming the above coating layer, further roll pressing may be performed. The roll press process can be performed at a temperature in a range of about 25° C. to about 110° C. When the roll press process is further performed, the coating layer is compressed, which may provide the advantage of shortening the Li ion movement path and improving the movement of lithium ions during charging and discharging.

When the coating layer includes both an organic layer and an inorganic layer, when the organic layer is formed first, insertion of inorganic particles into the electrode plate can be reduced or prevented when the inorganic layer is subsequently formed.

Next, the negative electrode active material layer coated with the organic layer is heat-treated at a temperature that is greater than or equal to about 50° C. and less than about 200° C. to form a coating layer on the negative electrode active material layer.

The above step may be or include a step in which polyamic acid electrospun onto a negative electrode active material layer is thermally imidized to prepare polyimide nanofibers. By including a quinoline-based derivative that constitutes a catalyst for low-temperature imidization in the solution for forming the organic layer, thermal imidization can be possible at a low temperature of less than about 200° C. For example, the thermal imidization temperature may be less than about 200° C., less than about 150° C., or less than or equal to about 140° C.

Next, the negative electrode and the positive electrode are located so as to be in contact with each other, thereby manufacturing an electrode assembly. For example, the positive electrode is located so as to be in contact with the negative electrode with a coating layer therebetween.

### Positive Electrode

A positive electrode for a rechargeable lithium battery may include a current collector, and a positive electrode active material layer on the current collector. The positive electrode active material layer includes a positive electrode active material, and may further include a binder and/or a conductive material.

For example, the positive electrode may further include an additive that can constitute a sacrificial positive electrode.

The positive electrode active material may include a compound (lithiated intercalation compound) capable of intercalating and deintercalating lithium. For example, at least one of a composite oxide of lithium and a metal such as or including at least one of cobalt, manganese, nickel, and combinations thereof, may be used.

The composite oxide may be or include a lithium transition metal composite oxide, and examples thereof may include at least one of lithium nickel-based oxide, lithium cobalt-based oxide, lithium manganese-based oxide, lithium iron phosphate-based compound, cobalt-free lithium nickel-manganese-based oxide, or a combination thereof.

As an example, the following compounds represented by any one of the following chemical formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); or LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

For example, the positive electrode active material may be or include a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol %, based on 100 mol % of the metal excluding lithium in the lithium transition metal composite oxide. The high-nickel-based positive electrode active material can realize high capacity and can be applied to a high-capacity, high-density rechargeable lithium battery.

An amount of the positive electrode active material may be in a range of about 90 wt % to about 99.5 wt % based on 100% by weight of the positive electrode active material layer, and amounts of the binder and the conductive material may be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethylcellulose, hydroxypropylcellulose, diacetylcellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but are not limited thereto.

The conductive material may impart conductivity to the electrode, and any material that does not cause adverse chemical change, and that conducts electrons, can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in a form of a metal powder or a metal fiber; a conductive polymer such as a polyphenylene derivative; or a mixture thereof.

Al may be used as the current collector, but the current collector is not limited thereto.

### Rechargeable Lithium Battery

Some example embodiments include a rechargeable lithium battery including the electrode assembly and an electrolyte solution.

An electrolyte solution for a rechargeable lithium battery includes a non-aqueous organic solvent and a lithium salt.

The non-aqueous organic solvent constitutes a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethylacetate, methylpropionate, ethylpropionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R-CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone, or in combination of two or more solvents.

In addition, when using a carbonate-based solvent, a cyclic carbonate and a chain carbonate may be mixed, and the cyclic carbonate and the chain carbonate may be mixed in a volume ratio in a range of about 1:1 to about 1:9.

The lithium salt dissolved in the organic solvent supplies lithium ions in a battery, enables an operation of a rechargeable lithium battery, and improves transportation of the lithium ions between positive and negative electrodes. For example, the lithium salt may include at least one of LiPF₆, LiBF₄, LiSbF₆, LiAsF₆, LiClO₄, LiAlO₂, LiAlCl₄, LiPO₂F₂, LICl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), x and y are integers in a range of 1 to 20, lithium trifluoromethane sulfonate, lithium tetrafluoroethanesulfonate, lithium difluorobis(oxalato)phosphate (LiDFOB), and lithium bis(oxalato) borate (LiBOB).

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

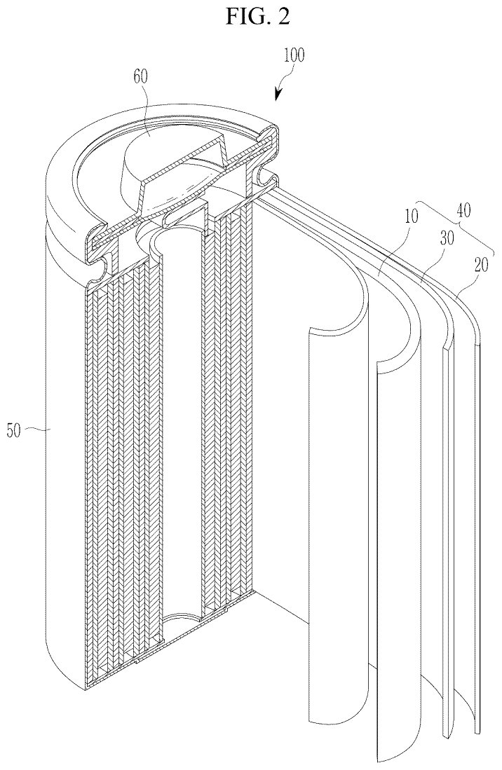

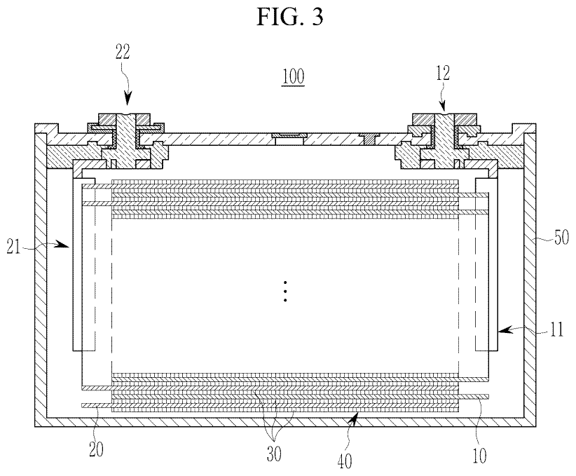

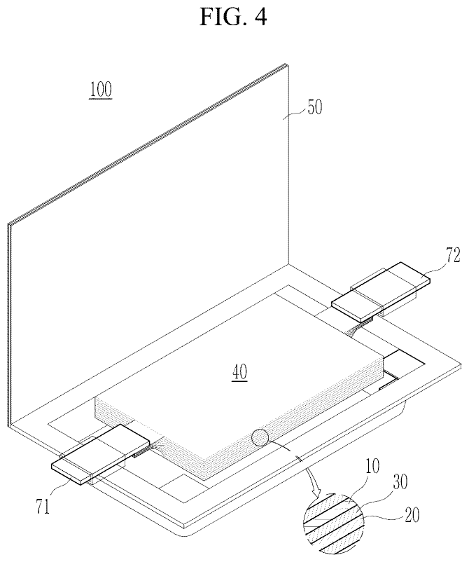

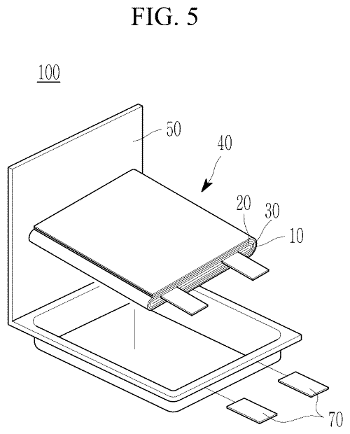

The rechargeable lithium battery may be classified into cylindrical, prismatic, pouch, coin, and the like depending on their shape. FIG. 2 to FIG. 5 are schematic views illustrating a rechargeable lithium battery according to some example embodiments. FIG. 2 shows a cylindrical battery, FIG. 3 shows a prismatic battery, and FIG. 4 and FIG. 5 show pouch-type batteries. Referring to FIG. 2 to FIG. 5, the rechargeable lithium battery 100 includes an electrode laminate 40 including a separator 30 between a positive electrode 10 and a negative electrode 20, and a case 50 in which the electrode laminate 40 is included. The positive electrode 10, the negative electrode 20, and the separator 30 may be impregnated with an electrolyte solution (not shown). The rechargeable lithium battery 100 may include a sealing member 60 that seals the case 50 as shown in FIG. 2. Additionally, in FIG. 3, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 4 and FIG. 5, the rechargeable lithium battery 100 includes an electrode tab 70 illustrated in FIG. 5, or a positive electrode tab 71 and a negative electrode tab 72 illustrated in FIG. 4, the electrode tabs 70/71/72 forming an electrical path for inducing the current formed in the electrode laminate 40 to the outside of the battery 100.

The rechargeable lithium battery according to an example embodiment may be applicable to, e.g., automobiles, mobile phones, and/or various types of electric devices, but the present disclosure is not limited thereto.

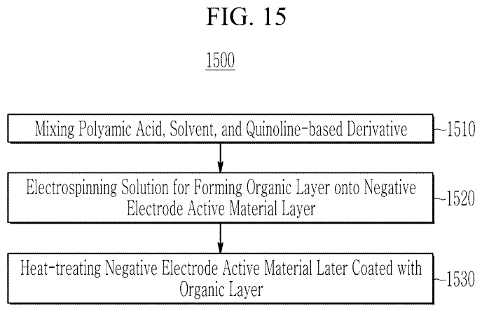

FIG. 15 is a flowchart illustrating a method of manufacturing an electrode assembly, according to an example embodiment. In examples, the method 1500 includes operation 1510 which includes mixing polyamic acid, a solvent, and a quinoline-based derivative to prepare a solution for forming an organic layer. For example, the quinoline-based derivative includes a compound represented by Chemical Formula 1:

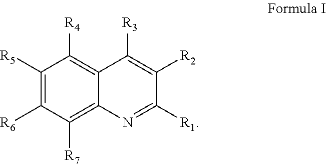

In Chemical Formula 1, R₁ to R₇ are the same or different and each independently includes at least one of hydrogen, a halogen, a hydroxyl group, a substituted or unsubstituted C1 to C30 alkyl group, a substituted or unsubstituted C1 to C10 alkylsilyl group, a substituted or unsubstituted C6 to C30 arylsilyl group, a substituted or unsubstituted C3 to C30 cycloalkyl group, a substituted or unsubstituted C3 to C30 heterocycloalkyl group, a substituted or unsubstituted C6 to C30 aryl group, a substituted or unsubstituted C2 to C30 heteroaryl group, a substituted or unsubstituted C1 to C20 alkoxy group, and a combination thereof.

In an example, R₁ to R₇ each independently includes at least one of hydrogen, a halogen, a hydroxyl group, a substituted or unsubstituted C1 to C30 alkyl group, and a combination thereof. In another example, a boiling point of the quinoline-based derivative is in a range of about 150° C. to about 300° C. In yet another example, a vapor pressure of the quinoline-based derivative is in a range of about 0.1 Pa to about 20 Pa.

Operation 1520 includes electrospinning the solution for forming the organic layer onto a negative electrode active material layer to manufacture a negative electrode active material layer coated with an organic layer. Operation 1530 includes heat-treating a negative electrode active material layer coated with the organic layer at a temperature greater than or equal to about 50° C. and less than about 200° C. to form a coating layer on the negative electrode active material layer.

Examples and comparative examples of the present disclosure are described below. However, the following examples are only examples of the present disclosure, and the present disclosure is not limited to the following examples.

### EXAMPLES

### Example 1

First, 97.5 wt % of artificial graphite, 1.0 wt % of carboxylmethyl cellulose, and 1.5 wt % of a styrene butadiene rubber (SBR) were mixed in a water solvent, preparing a negative electrode active material slurry. The negative electrode active material slurry was coated on a copper current collector, and dried and pressed to form a negative electrode active material layer.

Subsequently, polyamic acid was dissolved in a dimethyl acetate solvent to prepare a polyamic acid solution, which was mixed with quinoline represented by Chemical Formula 2 (a boiling point: 237° C./a vapor pressure: 8 Pa) to prepare a solution for forming an organic layer. Herein, the polyamic acid was included in an amount of 8 wt % based on 100 wt % of the solution for forming an organic layer, and the quinoline was included in an amount of 5 wt %.

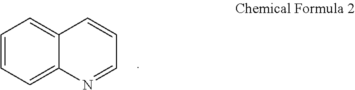

The prepared solution for forming an organic layer was electrospun to be 41 μm thick on the negative electrode active material layer, and then roll-pressed to obtain the negative electrode active material layer coated with a 15 μm-thick organic layer.

The negative electrode active material layer coated with the organic layer was heat-treated at 140° C. to prepare a negative electrode in which the organic layer including polyimide nanofiber was integrated with the negative electrode active material layer.

Herein, a content of the polyimide nanofiber was 95 wt % based on 100 wt % of the coating layer (organic layer), and a content of the quinoline represented by Chemical Formula 2 was 5 wt %.

Subsequently, 96 wt % of LiCoO₂, 2 wt % of Ketjen black, and 2 wt % of polyvinylidene fluoride were mixed in an N-methyl pyrrolidone solvent to prepare a positive electrode active material slurry. The positive electrode active material slurry was coated on an Al current collector, and then dried and pressed to prepare a positive electrode.

The prepared negative and positive electrodes were stacked to overlap each other, and thus obtain an electrode assembly. Herein, the organic layer of the negative electrode was placed to contact the positive electrode. The electrode assembly was used with an electrolyte to prepare a rechargeable lithium battery cell.

The electrolyte was prepared by dissolving LiPF₆ in a mixed solvent of ethylene carbonate and ethylmethyl carbonate (in a volume ratio of 50:50).

### Comparative Example 1

A solution for forming an organic layer according to Comparative Example 1 was prepared in the same manner as in Example 1, with a difference that the solution for forming an organic layer was prepared by excluding the quinoline.

The prepared solution for forming an organic layer was electrospun to be 78 μm thick on the negative electrode active material layer, and then roll-pressed to obtain a negative electrode active material layer coated with an organic layer with a thickness of 35 μm.

Subsequently, a negative electrode and a rechargeable lithium battery cell according to Comparative Example 1 were prepared in the same manner as in Example 1, with a difference that the negative electrode in which an organic layer including polyimide nanofiber was integrated with a negative electrode active material layer was prepared by coating the negative electrode active material layer with the organic layer and performing a heat treatment at 200° C.

### Comparative Example 2

A solution for forming an organic layer, a negative electrode, and a rechargeable lithium battery cell according to Comparative Example 2 were prepared in the same manner as in Example 1, with a difference that the solution for forming an organic layer was prepared by using pyridine (a boiling point: 115° C./a vapor pressure: 2600 Pa) instead of the quinoline.

### Comparative Example 3

A solution for forming an organic layer, a negative electrode, and a rechargeable lithium battery cell according to Comparative Example 3 were prepared in the same manner as in Example 1, with a difference that the solution for forming an organic layer was prepared by using benzoic acid (a boiling point: 250° C./a vapor pressure: 0.1 Pa) instead of the quinoline.

### EVALUATION EXAMPLES

### Evaluation Example 1: Evaluation of Electrospinning Properties

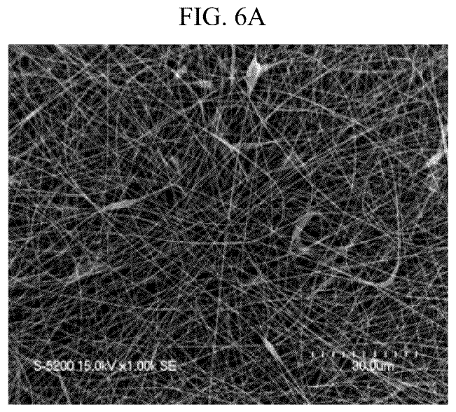

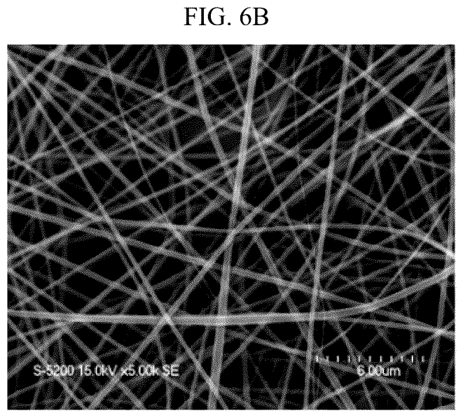

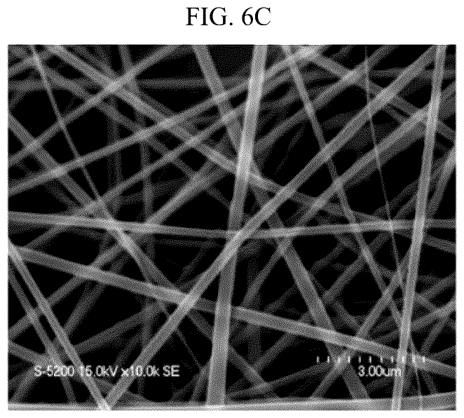

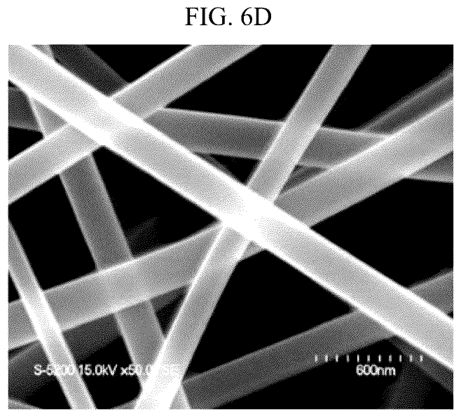

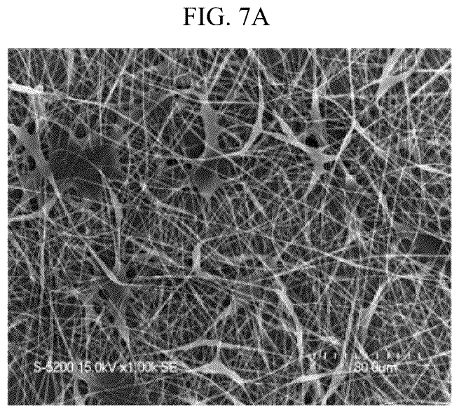

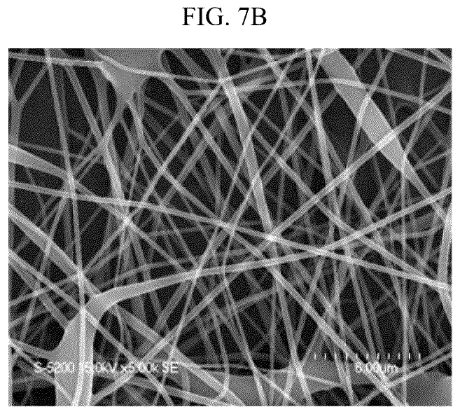

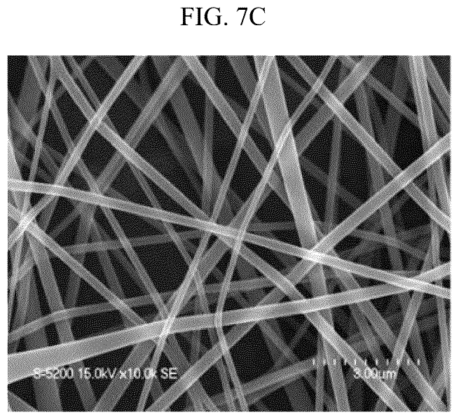

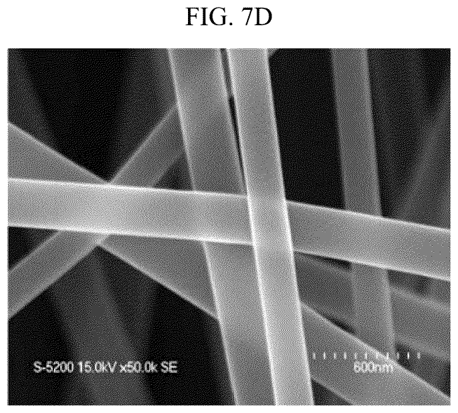

The polyimide nanofiber formed by the electrospinning on the negative electrode according to Example 1 was analyzed by SEM images at different magnifications, which are shown FIG. 6A to FIG. 6D, and the polyimide nanofiber formed by the electrospinning on the negative electrode according to Comparative Example 1 was analyzed by SEM images at different magnifications, which are shown in FIG. 7A to FIG. 7D.

Referring to FIG. 6A to FIG. 6D and FIG. 7A to FIG. 7D, Example 1, compared to Comparative Example 1, exhibited desired or improved electrospinning properties due to few droplets or beads-on-string structures on the nanofiber, and also a small nanofiber diameter.

### Evaluation Example 2: Evaluation of Diameter and Uniformity of Polyimide Nanofibers

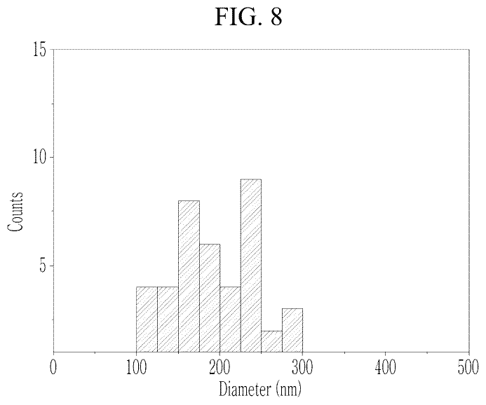

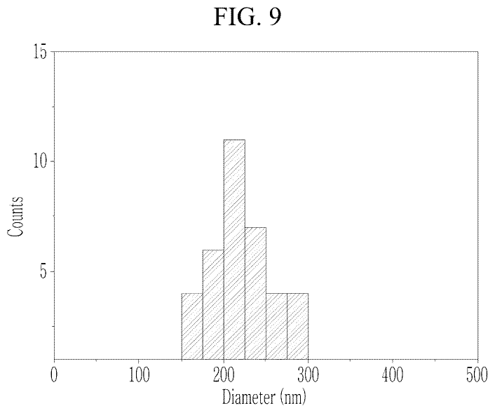

The polyimide nanofibers of Example 1 and Comparative Example 1 were measured with respect to an average diameter, a standard deviation of the diameter, a maximum value of the diameter, and a minimum value of the diameter, and the results are shown in Table 1 below and FIG. 8 and FIG. 9.

The average diameter of each of the polyimide nanofibers was obtained by taking a scanning electron microscope image of each coating layer of Example 1 and Comparative Example 1 to measure a diameter of about 50 randomly selected fibers, and calculate an arithmetic mean of the measurements.

The standard deviation of the polyimide nanofiber diameter was calculated by using the average diameter of each of the fibers of Example 1 and Comparative Example 1.

In addition, the maximum diameter of the polyimide nanofibers was obtained by measuring diameters of 50 fibers and taking the largest value among them, and the minimum diameter of the polyimide nanofibers was also obtained by measuring the diameters of 50 fibers and taking the smallest one among them.

TABLE 1

| | | Comparative |
|---|---|---|
| | Example 1 | Example 1 |
| Average diameter (nm) | 191.01 | 267.25 |
| Standard deviation of diameter (STDEV, nm) | 71.72 | 92.04 |
| Maximum value of diameter (nm) | 344.58 | 587.58 |
| Minimum value of diameter (nm) | 61.90 | 156.63 |

Referring to Table 1 and FIG. 7 and FIG. 8, compared to Comparative Example 1, Example 1 exhibited a decrease in the diameters of the polyimide nanofibers and a small standard deviation of the diameters, which confirms that uniformity of the diameters was improved.

### Evaluation Example 3: Evaluation of Low Temperature Imidization Possibility

The organic layers coated in the electrospinning method according to Example 1 and Comparative Example 1 were subjected to a differential scanning calorimetry (DSC) analysis.

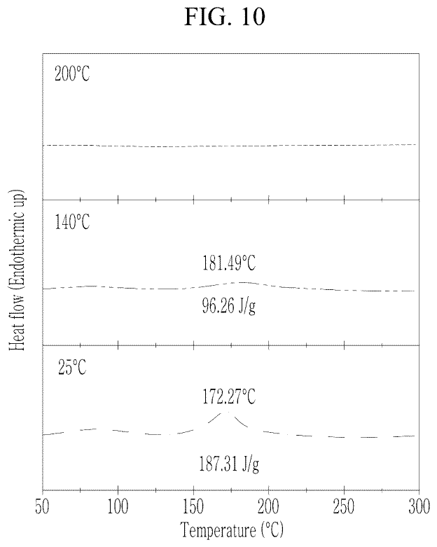

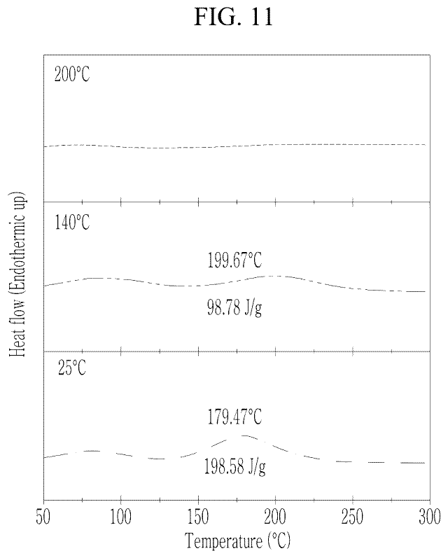

For example, after heat-treating the negative electrode active material layer electrospray-coated with the organic layer at 25° C./140° C./200° C., the coating layer (organic layer) alone was collected and subjected to DSC analysis when heated at 10° C./min within a temperature range of 50° C. to 300° C., and the results are shown respectively in FIG. 10 (Example 1) and FIG. 11 (Comparative Example 1).

In FIG. 10 and FIG. 11, an endothermic peak indicates that an imidization reaction occurred, wherein ΔH (J/g) at each endothermic peak was provided.

Referring to FIG. 10 and FIG. 11, Example 1 exhibited a decrease in ΔH at the endothermic peak by including quinoline, which confirmed that imidization was possible at a low temperature of 140° C. or so.

### Evaluation Example 4: Evaluation of Imidization Index

As in Evaluation Example 3, the organic layers coated in the electrospinning method according to Example 1 and Comparative Examples 1 to 3 were evaluated with respect to an imidization index of polyimide (a conversion rate of the polyamic acid to polyimide) by using FT-IR.

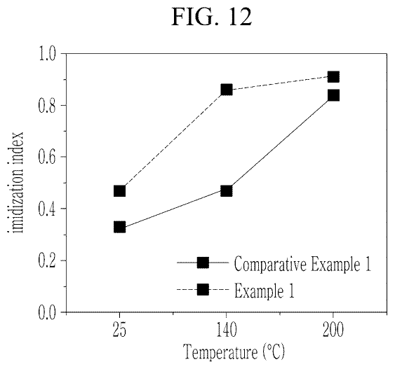

For example, while using a sample heat-treated at 350° C. for 1 hour as a reference, each sample was heat-treated at each imidization temperature (25° C., 140° C., 200° C.) to measure peak intensity by using Fourier transform infrared ray (FT-IR) spectroscopy, and calculate intensity ratios of specific peaks, which were used to calculate the imidization index, and the results are shown in Table 2 below and FIG. 12.

The imidization index is defined by Equation 1.

$$imidization index = \frac{{( {D}_{1380 {cm}^{- 1}} / {D}_{1500 {cm}^{- 1}} )}_{T}}{{( {D}_{1380 {cm}^{- 1}} / {D}_{1500 {cm}^{- 1}} )}_{350 ° C .}} \qquad Equation 1$$

Herein, D_{1500 cm-1} is the intensity of a peak corresponding to vibration of benzene, and D_{1380 cm-1} is the intensity of a peak corresponding to C-N-C stretching variation of an imide group.

TABLE 2

Imidization index

| | 25° C. | 140° C. | 200° C. |
|---|---|---|---|
| Example 1 | 0.47 | 0.86 | 0.91 |
| Comparative Example 1 | 0.33 | 0.47 | 0.84 |
| Comparative Example 2 | 0.40 | 0.74 | 0.85 |
| Comparative Example 3 | 0.52 | 0.90 | 0.95 |

Referring to Table 2 above and FIG. 12, Example 1 exhibited a higher imidization index, which was derived from FT-IR analysis data, at all the temperatures, than Comparative Example 1 and particularly, an imidization ratio of 0.86 at 140° C., where the electrode plate had no damage, which confirmed that the imidization ratio of 0.86 was significantly increased from 0.47 of Comparative Example 1, and that mechanical characteristics of the polyimide were improved.

In addition, Comparative Example 2, in which a large amount of pyridine was lost due to a low boiling point and a high vapor pressure of pyridine during the electrospinning process or the heat treatment process, exhibited a lower imidization ratio than Example 1.

In addition, Comparative Example 3, in which a large amount of benzoic acid remained due to a high boiling point and a low vapor pressure during the electrospinning process or the heat treatment process, exhibited the highest imidization ratio, wherein the large amount of benzoic acid constituted defects inside the nanofibers, deteriorating mechanical characteristics.

### Evaluation Example 5: Evaluation of Mechanical Properties According to Imidization Temperature

As in Evaluation Example 3, mechanical properties according to a thermal imidization temperature of the organic layers according to Example 1 and Comparative Examples 1 to 3 were evaluated as follows.

First, the coating layer samples of Example 1 and Comparative Examples 1 to 3 were respectively prepared at each imidization temperature of 25° C. and 140° C., and then fixed into a INSTRON universal tester.

The samples had each gauge length and width of 250 mm and 10 mm according to ASTM D882, to which a tensile load was applied at a tensile speed of 100 mm/min, until the samples were broken, to measure a maximum load, and the maximum load was divided by an initial cross-section area of each of the samples to obtain maximum tensile strength (MPa). The maximum tensile strain was calculated as a strain (obtained by dividing a difference between the deformed length and the initial length by the initial length) at a point where each of the samples was broken, and Young's modulus (MPa) was calculated by measuring a slope of a strain range in an elastic strain region of 0.05% to 0.25% in a strain-stress curve.

The coating layer samples according to Example 1 and Comparative Examples 1 to 3 according to the imidization temperatures were measured with respect to maximum tensile strength (MPa), maximum tensile strain (%), Young's modulus (MPa), and each standard deviation of these three values, and the results are shown in Tables 3 to 6 below.

TABLE 3

| | Maximum tensile | Maximum tensile | |
|---|---|---|---|
| Example 1 | strength | strain | Young's modulus |
| imidization | (Mpa)/(standard | (%)/(standard | (Mpa)/(standard |
| temperature | deviation) | deviation) | deviation) |
| 25° C. | 67.28/4.44 | 9.52/4.77 | 1977.61/(192.31) |
| 140° C. | 71.37/4.22 | 7.68/1.57 | 1475.61/(259.47) |

TABLE 4

| Comparative | Maximum tensile | Maximum tensile | |
|---|---|---|---|
| Example 1 | strength | strain | Young's modulus |
| imidization | (Mpa)/(standard | (%)/(standard | (Mpa)/(standard |
| temperature | deviation) | deviation) | deviation) |
| 25° C. | 53.75/4.24 | 11.19/2.37 | 1915.23/(164.17) |
| 140° C. | 66.38/3.30 | 7.57/2.44 | 1456.58/(370.28) |

TABLE 5

| Comparative | Maximum tensile | Maximum tensile | |
|---|---|---|---|
| Example 2 | strength | strain | Young's modulus |
| imidization | (Mpa)/(standard | (%)/(standard | (Mpa)/(standard |
| temperature | deviation) | deviation) | deviation) |
| 25° C. | 60.35/4.30 | 10.12/3.0 | 1959.23/(182.13) |
| 140° C. | 68.31/3.80 | 7.65/2.31 | 1460.42/(343.18) |

TABLE 6

| Comparative | Maximum tensile | Maximum tensile | |
|---|---|---|---|
| Example 3 | strength | strain | Young's modulus |
| imidization | (Mpa)/(standard | (%)/(standard | (Mpa)/(standard |
| temperature | deviation) | deviation) | deviation) |
| 25° C. | 32.22/2.90 | 9.78/2.44 | 1740.16/(226.33) |
| 140° C. | 51.74/5.92 | 6.89/3.81 | 1260.42/(379.29) |

Referring to Tables 3 and 4, at room temperature (25° C.), Example 1 exhibited larger tensile strength than Comparative Example 1, which confirmed that Example 1 included quinoline, which chemically imidized a portion of polyamic acid, and thus improved mechanical properties.

In addition, compared to Comparative Example 1, Example 1 exhibited high maximum tensile strength at the imidization at 140° C., an increase in maximum tensile strain and thus strong flexibility, and an increase in Young's modulus and thus desired or improved mechanical properties.

Referring to Tables 5 and 6 above, Comparative Examples 2 and 3 exhibited all lower tensile strength, tensile strain, and Young's modulus than Example 1 in the imidization at 140° C. and thus deteriorated mechanical properties, compared to Example 1.

Particularly, Comparative Example 3 exhibited the lowest mechanical properties due to a large amount of residual benzoic acid.

### Evaluation Example 6: Evaluation of Battery Characteristics

The rechargeable lithium battery cells of Example 1 and Comparative Example 1 were evaluated with respect to initial efficiency characteristics.

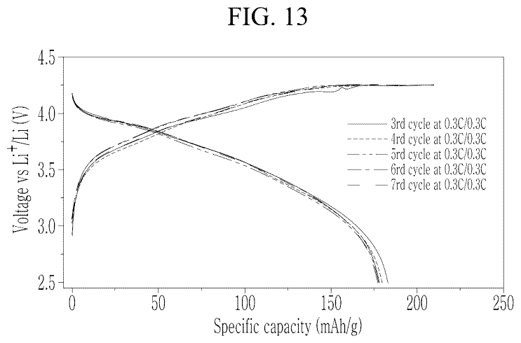

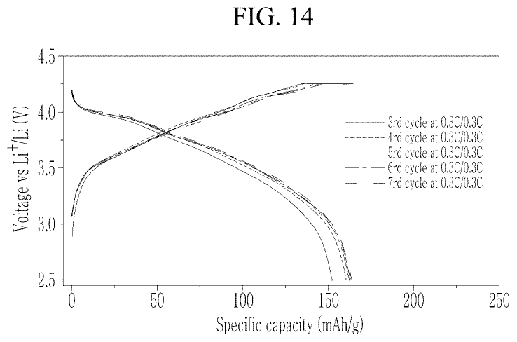

First, the cells were once charged under conditions of CC-CV mode 0.2 C and 4.2 V/0.05 C cut-off and discharged under conditions of CC-mode 0.2 C and 2.5 V cut-off to proceed with formation. Subsequently, the cells were 3 times to 7 times repeatedly charged under conditions of CC-CV mode 1.0 C, 4.2 V/0.05 C cut-off and discharged under conditions of CC-mode 1.0 C and 2.5 V cut-off to evaluate initial efficiency characteristics, and the results are respectively shown in FIG. 13 (Example 1) and FIG. 14 (Comparative Example 1).

Referring to FIG. 13 and FIG. 14, compared to Comparative Example 1, Example 1 exhibited an increase in capacity at the beginning of cycles.

While this disclosure has been described in connection with what is presently considered to be practical example embodiments, it is to be understood that the disclosure is not limited to the disclosed embodiments, but, on the contrary, is intended to cover various modifications and equivalent arrangements included within the spirit and scope of the appended claims.

Description of Symbols:

| | |
|---|---|
| 1: electrode assembly | 2: current collector |
| 3: negative electrode active material layer | 5: coating layer |
| 20: negative electrode | 10: positive electrode |

100: rechargeable lithium battery
11: positive electrode lead tab
12: positive electrode terminal
21: negative electrode lead tab
22: negative electrode terminal
30: separator

| | |
|---|---|
| 40: electrode laminate | 50: case |
| 60: sealing member | 70: electrode tab |
| 71: positive electrode tab | 72: negative electrode tab |

What is claimed is:

1. An electrode assembly, comprising:
a negative electrode including a current collector, a negative electrode active material layer on the current collector, and a coating layer on the negative electrode active material layer; and
a positive electrode,
wherein the coating layer comprises an organic layer including polyimide nanofibers and a quinoline-based derivative, and
an average diameter of the polyimide nanofibers is less than or equal to about 200 nm.

2. The electrode assembly as claimed in claim 1, wherein the coating layer is integrated with the negative electrode active material layer.

3. The electrode assembly as claimed in claim 1, wherein the average diameter of the polyimide nanofibers is less than or equal to about 195 nm.

4. The electrode assembly as claimed in claim 1, wherein:
a standard deviation of a diameter of the polyimide nanofibers is in a range of about 50 nm to about 90 nm,
a maximum value of a diameter of the polyimide nanofibers is in a range of about 250 nm to about 500 nm, and
a minimum value of a diameter of the polyimide nanofibers is in a range of about 40 nm to about 100 nm.

5. The electrode assembly as claimed in claim 1, wherein an imidization index at 140° C. derived from FT-IR analysis data of the polyimide nanofibers is in a range of about 0.8 to about 0.9.

6. The electrode assembly as claimed in claim 1, wherein the quinoline-based derivative comprises a compound represented by Chemical Formula 1: 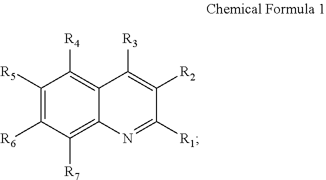
wherein, in Chemical Formula 1, R₁ to R₇ are the same or different and each independently comprises at least one of hydrogen, a halogen, a hydroxyl group, a substituted or unsubstituted C1 to C30 alkyl group, a substituted or unsubstituted C1 to C10 alkylsilyl group, a substituted or unsubstituted C6 to C30 arylsilyl group, a substituted or unsubstituted C3 to C30 cycloalkyl group, a substituted or unsubstituted C3 to C30 heterocycloalkyl group, a substituted or unsubstituted C6 to C30 aryl group, a substituted or unsubstituted C2 to C30 heteroaryl group, a substituted or unsubstituted C1 to C20 alkoxy group, and a combination thereof.

7. The electrode assembly as claimed in claim 6, wherein R₁ to R₇ each independently comprises at least one of hydrogen, a halogen, a hydroxyl group, a substituted or unsubstituted C1 to C30 alkyl group, and a combination thereof.

8. The electrode assembly as claimed in claim 1, wherein a boiling point of the quinoline-based derivative is in a range of about 150° C. to about 300° C.

9. The electrode assembly as claimed in claim 1, wherein a vapor pressure of the quinoline-based derivative is in a range of about 0.1 Pa to about 20 Pa.

10. The electrode assembly as claimed in claim 1, wherein a content of the polyimide nanofibers is in a range of about 50 wt % to about 100 wt % based on 100 wt % of the coating layer.

11. The electrode assembly as claimed in claim 1, wherein a content of the quinoline-based derivative is in a range of about 0.1 wt % to about 5 wt % based on 100 wt % of the coating layer.

12. The electrode assembly as claimed in claim 1, wherein:
the organic layer is a porous layer including a plurality of pores, and
an average diameter of the pores is less than or equal to about 200 nm.

13. The electrode assembly as claimed in claim 1, wherein at least a portion of the polyimide nanofibers is penetrated into the inside of the negative electrode active material layer.

14. The electrode assembly as claimed in claim 1, wherein:
the coating layer further comprises an inorganic layer, and
the inorganic layer comprises at least one of alumina (Al₂O₃), boehmite (aluminum oxide hydroxide), zirconia, titanium oxide (TiO₂), silica (SiO₂), and a combination thereof.

15. The electrode assembly as claimed in claim 1, wherein a thickness of the coating layer is in a range of about 1 μm to about 25 μm.

16. The electrode assembly as claimed in claim 1, wherein a thickness of the organic layer is in a range of about 1 μm to about 25 μm.

17. The electrode assembly as claimed in claim 1, wherein a peel strength of the coating layer is in a range of about 0.1 gf/mm to about 3.0 gf/mm.

18. A method for manufacturing an electrode assembly, the method comprising:
mixing polyamic acid, a solvent, and a quinoline-based derivative to prepare a solution for forming an organic layer;
electrospinning the solution for forming the organic layer onto a negative electrode active material layer to manufacture a negative electrode active material layer coated with an organic layer; and
heat-treating a negative electrode active material layer coated with the organic layer at a temperature greater than or equal to about 50° C. and less than about 200° C. to form a coating layer on the negative electrode active material layer.

19. The method as claimed in claim 18, wherein the quinoline-based derivative comprises a compound represented by Chemical Formula 1: 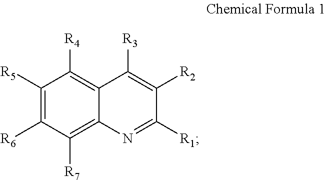
wherein, in Chemical Formula 1, R₁ to R₇ are the same or different and each independently comprises at least one of hydrogen, a halogen, a hydroxyl group, a substituted or unsubstituted C1 to C30 alkyl group, a substituted or unsubstituted C1 to C10 alkylsilyl group, a substituted or unsubstituted C6 to C30 arylsilyl group, a substituted or unsubstituted C3 to C30 cycloalkyl group, a substituted or unsubstituted C3 to C30 heterocycloalkyl group, a substituted or unsubstituted C6 to C30 aryl group, a substituted or unsubstituted C2 to C30 heteroaryl group, a substituted or unsubstituted C1 to C20 alkoxy group, and a combination thereof.

20. The method as claimed in claim 19, wherein R₁ to R₇ each independently comprises at least one of hydrogen, a halogen, a hydroxyl group, a substituted or unsubstituted C1 to C30 alkyl group, and a combination thereof.

21. The method as claimed in claim 18, wherein a boiling point of the quinoline-based derivative is in a range of about 150° C. to about 300° C.

22. The method as claimed in claim 18, wherein a vapor pressure of the quinoline-based derivative is in a range of about 0.1 Pa to about 20 Pa.

23. A rechargeable lithium battery comprising:
the electrode assembly as claimed in claim 1; and
an electrolyte.
